(19) United States
(12) Patent Application Publication
(10) Pub. No.: US 2020/0000048 A1
(43) Pub. Date: Jan. 2, 2020

(54) STACKABLE AND TIERED MODULAR KIT, ASSEMBLY AND METHOD INCLUDING A PLURALITY OF HOOP SHAPED COMPONENTS FOR SUPPORTING A STEM OF A GROWING PLANT

(71) Applicant: Kevin M. Daniel, Port Huron, MI (US)

(72) Inventor: Kevin M. Daniel, Port Huron, MI (US)

(21) Appl. No.: 16/566,046

(22) Filed: Sep. 10, 2019

Related U.S. Application Data
(63) Continuation-in-part of application No. 15/385,413, filed on Dec. 20, 2016.
(60) Provisional application No. 62/272,563, filed on Dec. 29, 2015.

(51) Int. Cl. A01G 9/12

(52) U.S. Cl. CPC A01G 9/124; A01G 9/128

(57) ABSTRACT

A kit for providing stem, branch and foliage support for a planting. The kit includes a plurality of hoop shaped bodies, each exhibiting an open interior adapted to encircle and support the planting. A plurality of vertically elongated portions secured about a perimeter of each of said bodies and include upper and lower inter-engaging ends for stacking the bodies in vertically spaced apart and tiered defining fashion. A plurality of elongated ground engagement stakes each include a flattened and intermediate located planar surface adapted for embedding the stakes in combination with an upper located pair of finger graspable retrieval tabs adapted for retracting the stakes. Each of the stakes further include an upper end securing the lower inter-engaging ends of a lower most hoop shaped body.

### CROSS REFERENCE TO RELATED APPLICATIONS

The present application is a continuation in part of U.S. Ser. No. 15/385,413 filed Dec. 20, 2016. The '413 application claims the priority of U.S. Ser. No. 62/272,563 filed Dec. 29, 2015, the contents of which are incorporated herein in their entirety.

### FIELD OF THE INVENTION

The present invention relates generally to a modular plant support kit, assembly and method of assembly. More particularly, the present invention teaches such a kit, assembly and method incorporating a plurality of hoop shaped components which can be arranged in vertically ascending/tiered fashion in order to support the stem of a growing plant.

### BACKGROUND OF THE INVENTION

The prior art is documented with various examples of stackable or module plant support structures. The purpose of such structures or assemblies is to provide a vertically ascending or tiered support to a growing plant stem.

A first example from the prior art is described in U.S. Pat. No. 8,567,120, to Davis et al., which teaches a modular support for vine plants and tomato plants having a solid, cylindrical base with holes to accept posts and associate tier rings. A cover may also be provided to transform the base into a miniature hot house. Notches may be formed in the rim of the base to accommodate irrigation systems and stake ends may be provided for the posts to allow immediate securement of the posts to the ground rather than the base. The solid base contains water, mulch and other beneficial compounds for the plants and helps block the spread of weeds immediately around the plant. As the plant grows, additional tiers may be added to the support to increase its size. The parts are preferably made of a durable plastic so as to support larger plants and increase longevity of the support.

A second example is shown in Wilbanks, Jr. et al., U.S. Pat. No. 7,478,501, which teaches a modular plant support system for supporting growing plants made up of a stacked interlocking layers of cylindrical split rings. The split rings are flexible and modular and configured to interconnect end to end so as to form a plant support layer of any reasonable diameter by coupling multiple sections. The layers of the plant support stand may be stacked and interconnected to form a plant support system of a height suited to support requirements of the plant.

Elliott, U.S. Pat. No. 5,640,802, teaches a support assembly for growing tomato plants which allows ready access to the plant during the various stages of growth by utilizing interchangeable parts. These include post sections having a tapered member (A) on a bottom end and a tapered socket (B) on the other end for joining the sections to form continuous posts having vertically spaced seating locations (C), and horizontal supports (D) having sockets (E) which fit securely onto post sections and spaced vertically to form modules that may be stacked in vertical relation and thereby added progressively to meet the needs engendered by growth of the plant and to permit ready access to the plant.

Brown, US 2015/0113869, teaches a plant growing system which protects plants during spring, for early and/or fast growth, and supports the plants later in the growing season. Frames hold panels that protect the plants by enclosing, shielding, and/or shading the interior growing space, and upon removal of the panels, the frames may support the larger plants and their fruit/vegetables. Multiple cooperating frames pivotally connect to form modular units of various sizes and shapes, and a latching/locking feature may stabilize the unit by preventing accidental disconnection of the frames. The frames may include feature(s) that allow, and stabilize, stacking of multiple units for accommodating taller plants. The panels held by the frames may be translucent/transparent, opaque, or a combination of the two, for customizing the interior environment inside each modular unit to the plant(s), the time of year, and/or the location and climate.

Other references of note include each of the trellis and tool system of Miller U.S. Pat. No. 7,874,100 which includes multiple legs and horizontal supports, the collapsible plant support structure of Shulman U.S. Pat. No. 6,453,606 and the modular planter system of Schultz U.S. Pat. No. 4,561,208.

### SUMMARY OF THE INVENTION

The present invention teaches a kit and assembly incorporating a plurality of hoop shaped components for supporting a stem of a plant. Each of the hoop shaped components exhibits a plurality of vertically integrated and elongated tier defining portions arranged in perimeter defined fashion about the hoops, an intermediate location of each of an individual plurality of tier defining portions being integrated into each hoop.

The tier defining portions each exhibit upper and lower inter-engaging locations for stacking any plurality of hoop shaped components in vertically spaced apart and tiered defining fashion. Optional elongated and height extending portions can be interposed between the integrated tier defining portions in order to increase the vertical spacing between respective hoop shaped components. Each of the hoop shaped components can include a disk shape with an inner perimeter rim edge, and so that a lower-most hoop component can be configured to engage an upper rim location of a plant supporting bucket in a first supporting arrangement.

A plurality of feet stakes are provided and, in a second mounting arrangement, can engage the lower engaging locations associated with the bottom most tiered hoop shaped component, the feet stakes being further adapted to embed in a soil location associated with a field or garden planted stem. The feet stakes each further include a flattened intermediate planar surface, such as having any of a round or elliptical shape, in combination with an upper located pair of finger graspable retrieval/withdrawal wings or tabs which permit easy retraction and removal of the ground stakes.

An associated method is also disclosed for utilizing a modularly stackable kit for providing stem, branch and foliage support for a planting, and which includes the steps of providing a plurality of hoop shaped components, each exhibiting an open interior adapted to encircle and support the planting, providing a plurality of vertically elongated portions arranged in perimeter defined fashion about each of the components, such that an intermediate location of each of an individual plurality of the tier defining portions is integrated into each of the hoop components.

Additional steps include providing a plurality of elongated ground engagement stakes, embedding the stakes in the ground by pressing down on a flattened planar surface at an intermediate location of each of the stakes and subsequently removing the stakes by engaging a pair of finger graspable retrieval tabs located above the flattened planar surface.

Yet addition steps include arranging a first of the plurality of shaped components proximate a base of the planting so that lower ends of the vertically elongated portions inter-engage with upper ends of the ground engagement stakes and successively installing at least one additional of the plurality of hoop shaped components by interengaging upper and lower opposing ends of the vertically elongated portions of the succeeding components in tiered defining fashion around the planting.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an exploded view of the kit and assembly according to a first variant and which includes a selected hoop shaped component which exhibits a plurality of vertically integrated and elongated tier defining portions arranged in perimeter defined fashion about the hoop, as well as showing elongated and height extending portions interposed between the integrated tier defining portions in order to increase the vertical spacing between respective hoop shaped components and feet stakes engageable with lowermost engaging locations associated with the bottom most tiered hoop shaped component;

FIG. 2 is a front plan view of the exploded embodiment of FIG. 1 and further illustrating, in phantom, a plant bucket having an upper rim location to which a lower-most hoop component can be configured to engage in a further supporting arrangement not requiring the feet stakes;

FIG. 3 is a top plan view of the embodiment of FIGS. 1-2 and illustrating the height extending portions and feet stakes positionally radially outwardly from the perimeter of the hoop shaped component for purposes of clarity of presentation;

FIG. 4 is a ninety degree rotated side plan view of the exploded embodiment of FIG. 2;

FIG. 5 is a bottom plan view of the embodiments of FIGS. 1-4;

FIG. 6 is an assembled perspective view of the modular kit and assembly according to a further variant without use of the intermediate spacers;

FIG. 7 is an exploded perspective view of the kit and assembly shown in FIG. 6;

FIG. 8 is an assembled front plan view of variant of FIG. 6;

FIG. 9 is an exploded view of the kit and assembly according to a further variant and which again includes a selected hoop shaped component which exhibits a plurality of vertically integrated and elongated tier defining portions arranged in perimeter defined fashion about the hoop, as well as showing elongated and height extending portions interposed between the integrated tier defining portions in order to increase the vertical spacing between respective hoop shaped components, along with feet stakes engageable with lowermost engaging locations associated with the bottom most tiered hoop shaped component;

FIG. 10 is a front plan view of the exploded embodiment of FIG. 9 and further illustrating, in phantom, a plant bucket having an upper rim location to which a lower-most hoop component can be configured to engage in a further supporting arrangement not requiring the feet stakes;

FIG. 11 is a top plan view of the embodiment of FIGS. 9-10 and illustrating the height extending portions and feet stakes positionally radially outwardly from the perimeter of the hoop shaped component for purposes of clarity of presentation;

FIG. 12 is a ninety degree rotated side plan view of the exploded embodiment of FIG. 10; and

FIG. 13 is a bottom plan view of the embodiments of FIGS. 9-12.

### DETAILED DESCRIPTION OF THE PREFERRED EMBODIMENTS

As will be described with reference to the appended illustrations, the present invention teaches a kit and assembly incorporating a plurality of hoop shaped components for supporting a stem of a plant. The kit can be reconfigured in a number of different ways in order to provide constraining support to the stem, branches and foliage of a growing planting (generally identified to include any of a tree, shrub or plant). The modular nature of the kit is further such that it can be easily tiered or stacked in order to track the growth of the planting, and for as long as is necessary to provide the desired degree of support.

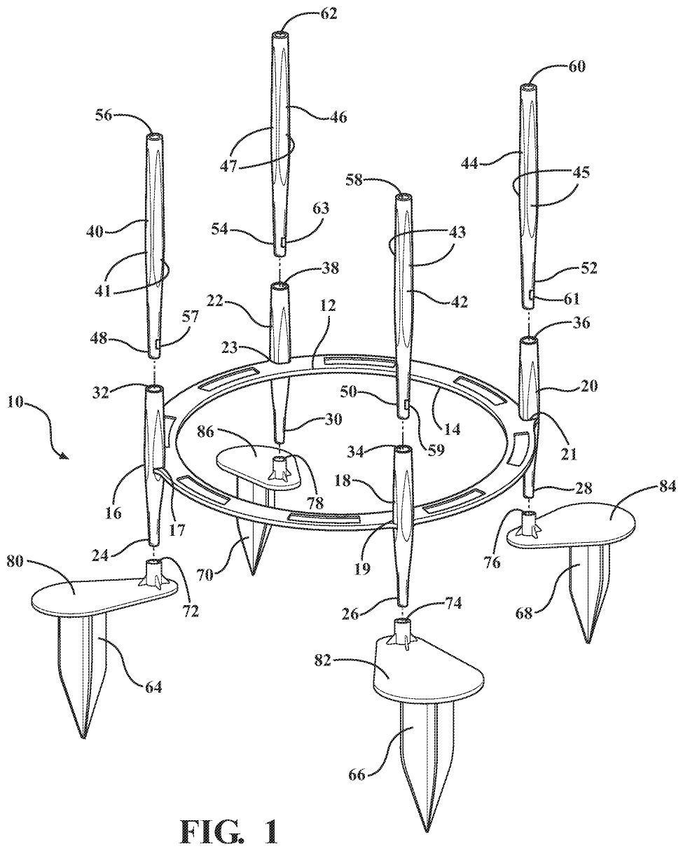

FIG. 1 is an exploded view, generally at 10, of the kit and assembly according to a first variant and which includes a selected hoop shaped component 12 which, as shown, exhibits a generally circular shape and can, without limitation, be constructed of a durable thermoplastic material (e.g. such as by a suitable injection molding operation), it being further understood that the individual components can be constructed of any other suitable material providing the necessary characteristics and not limited to plastics or metals. The hoop shaped component 12 can further have any polygonal or closed inner facing profile (see surface 14) and may also exhibit flexural properties.

A plurality of vertically integrated and elongated tier defining portions, see four such portions at 16, 18, 20 and 22, are arranged in perimeter defined and integrated fashion about the hoop shaped component 12, such that an intermediate extending portion or location (see at 17, 19, 21 and 23, respectively) of each tier defining portion is molded or otherwise affixed to such as an outer surface of the hoop shaped component. Without limitation, any sub-plurality of such tier defining portions (two, three, five, etc.) can be provided for each hoop shaped component, these being identically configured in order to provide for modularized stack-ability in order to arrange any number of hoop shaped components in a tiered fashion to maintain a desired supporting arrangement for the growing planting.

The vertically integrated and elongated portions 16, 18, 20 and 22 each further include upper and lower inter-engaging ends, these illustrated in non-limiting example by lower male inserting portions 24, 26, 28 and 30, as well as by upper female socket receiving portions 32, 34, 36 and 38. It is further envisioned and understood that any other interlocking arrangement (such as including tab and slot or other) can be established between the respective upper and lower mounting ends of each tier defining portion without limitation.

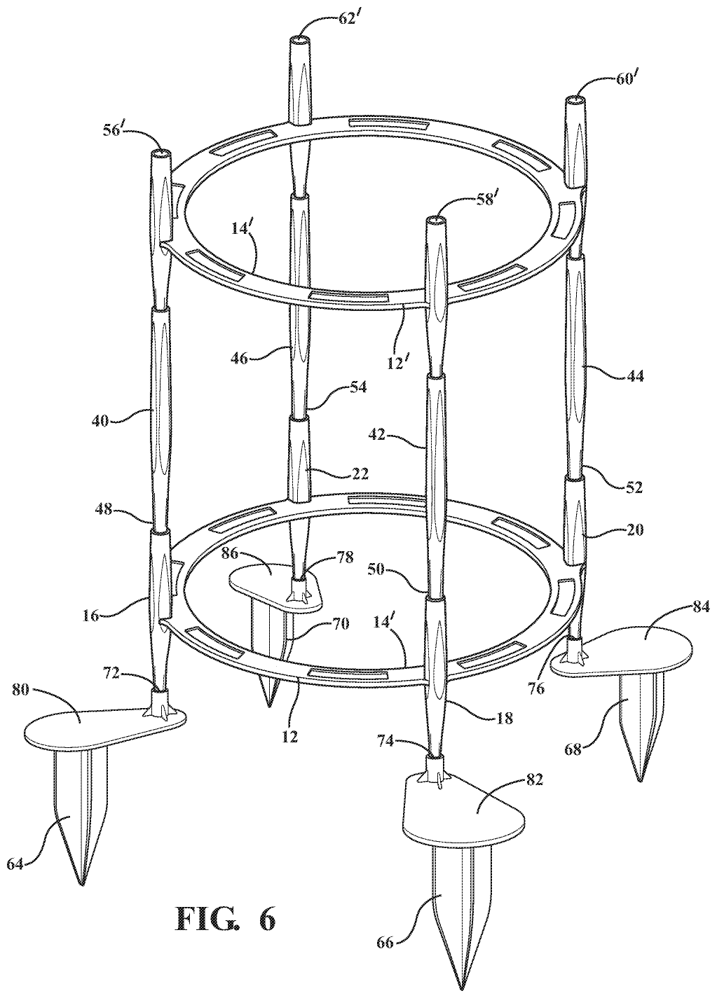

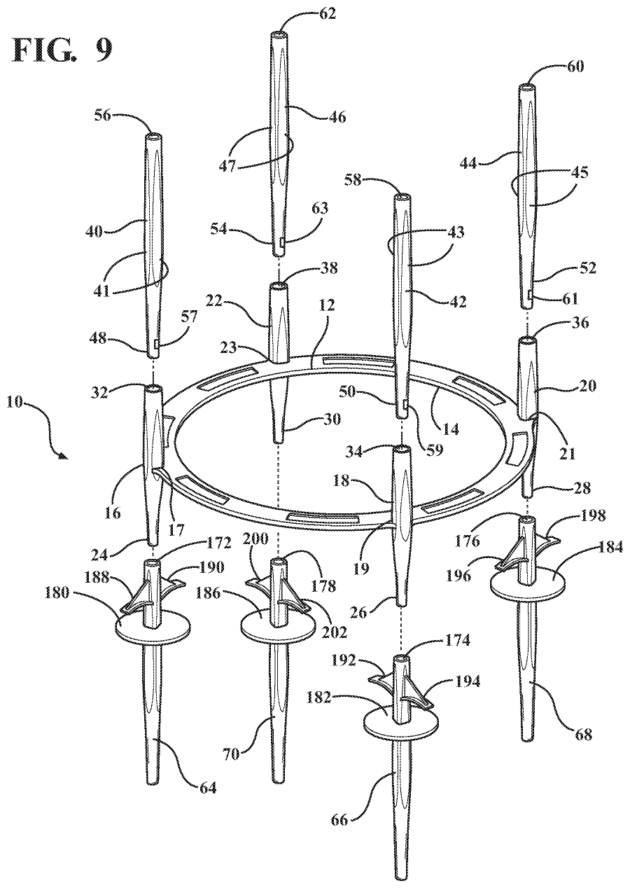

As will be illustrated with reference to the additional drawings, the hoop shaped components can be directly stacked atop one another in multi-tiered fashion (see FIGS. 6-8). As further shown in FIG. 1, an alternate variant includes the provision of a plurality of elongated and height extending portions, see at 40, 42, 44 and 46, interposed between successive aligning and integrated tier defining portions (this shown in FIGS. 9-11) associated with successive and identically configured hoop shaped components, this in order to increase the vertical spacing between respective hoop shaped components.

The height extending portions 40, 42, 44 and 46 can exhibit any circular or polygonal cross sectional profile (see perspective configuration in FIG. 1 with circumferentially offset details 41, 43, 45 and 47 in FIG. 1), and each include lower end disposed inter-engaging portions (e.g. male inserting portions 48, 50, 52 and 54), as well as upper end disposed female socket portions (at 56, 58, 60 and 62), and so that the height extending portions inter-fit with the inter-engaging ends of the respective tier defining portions. The lower end portions can also include additional details, see at 57, 59, 61 and 63 in FIG. 1, which can provide additional frictional inter-fitting within the receiving interiors of the upper female socket receiving portions 32, 34, 36 and 38 of the vertically integrated portions 16, 18, 20 and 22.

A first mounting arrangement for a lower most positioned hoop shaped component 12 (again FIG. 1) is further provided by a plurality of feet stakes 64, 66, 68 and 70, these corresponding in number to the given plurality of tier defining portions integrated into the hop shaped component. As shown, the feet stakes can each include an upper end receiving socket (at 72, 74, 76 and 78 respectively) engageable with the lowermost engaging locations (male lower ends 24, 26, 28 and 30) associated with the bottom most tiered hoop shaped component.

Without limitation, the feet stakes 64, 66, 68 and 70 depicted include a flattened intermediate planar surface (at 80, 82, 84 and 86) which separate the lower projecting spike locations (again shown at 64-70) from the upper disposed receiving sockets 72-78. In this fashion, the planar surfaces can provide ease of press embedding (such as by the user's foot) into the turf location associated with a field or garden in which the desired planting is located. It is also understood that the feet stakes can exhibit any other desired shape or configuration without limitation and is understood to not be limited to that depicted herein.

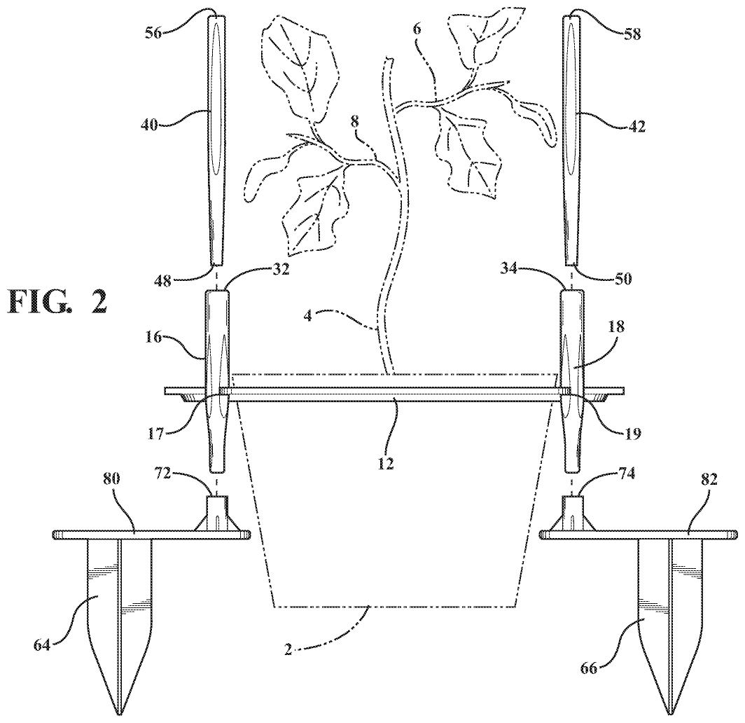

As further shown in corresponding FIG. 2, each of the hoop shaped components can include a disk shape with its inner perimeter rim edge 14 associated with a lower-most hoop component configured to engage a plant bucket 2, illustrated in phantom, the plant bucket having an upper rim location to which the lower-most hoop component can be configured to engage in a further supporting arrangement not requiring the feet stakes. As further shown in FIG. 2, the stem 4 and branches/foliage (collectively referenced at 6 and 8) extend upwardly from the bucket 2 (or ground location) and which are constrained by the tiered hoop shaped components.

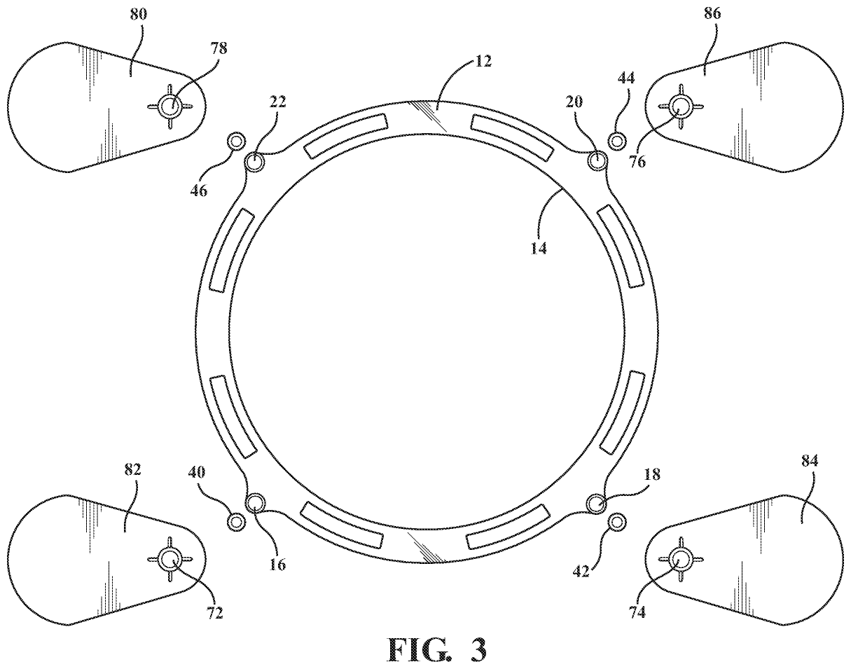

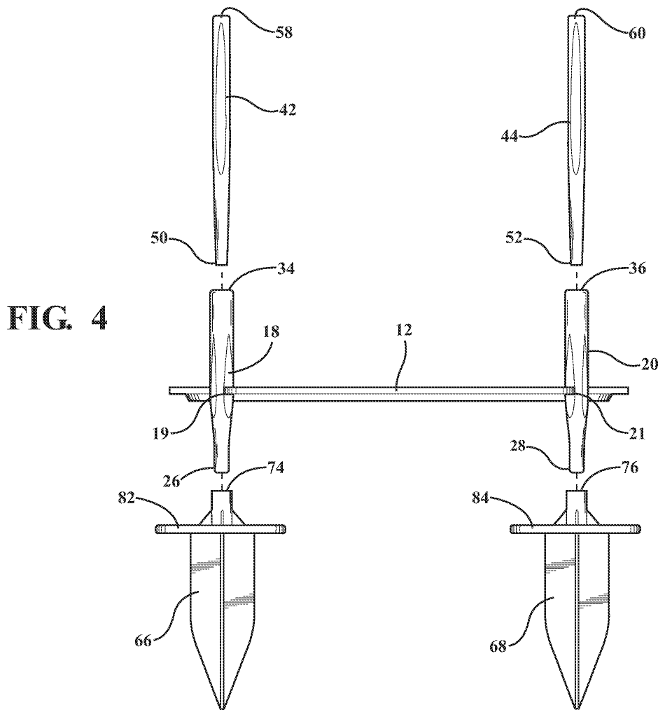

FIG. 3 is a top plan view of the embodiment of FIGS. 1-2 and illustrating the height extending portions and feet stakes positionally radially outwardly from the perimeter of the hoop shaped component for purposes of clarity of presentation. FIG. 4 is a ninety degree rotated side plan view of the exploded embodiment of FIG. 2.

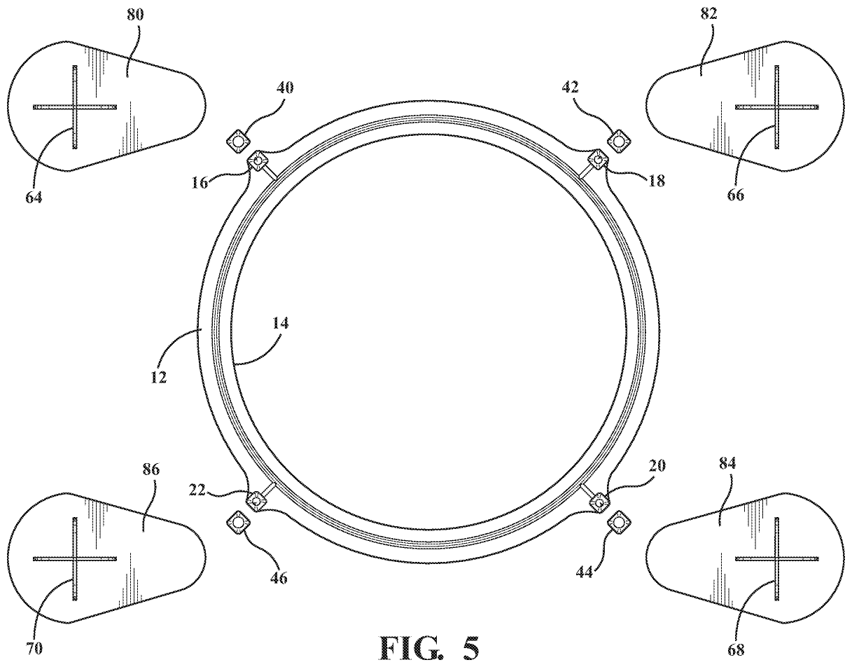

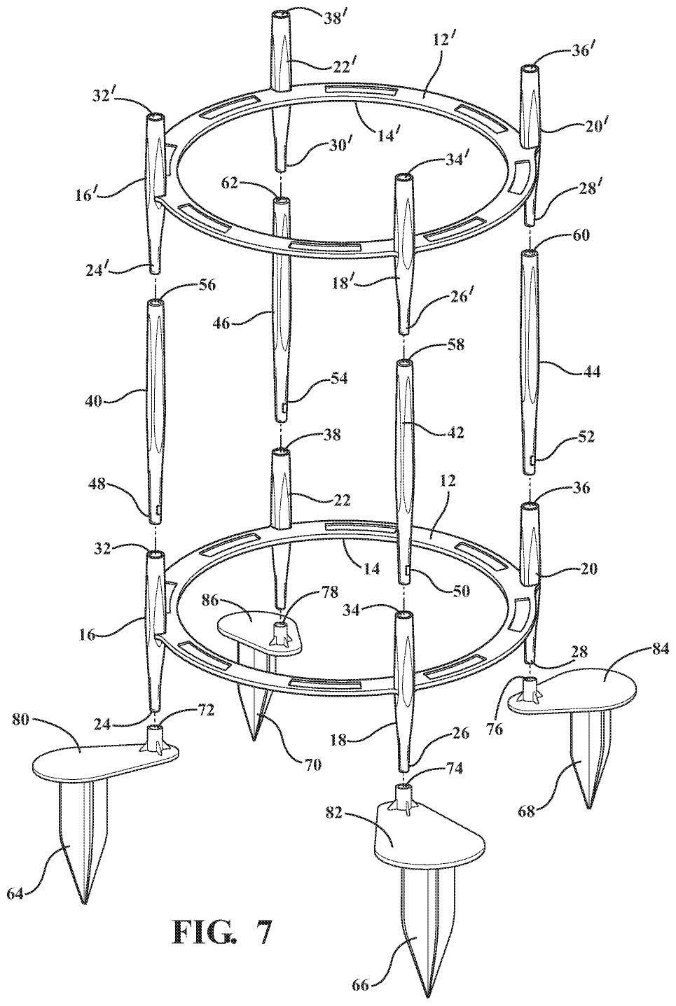

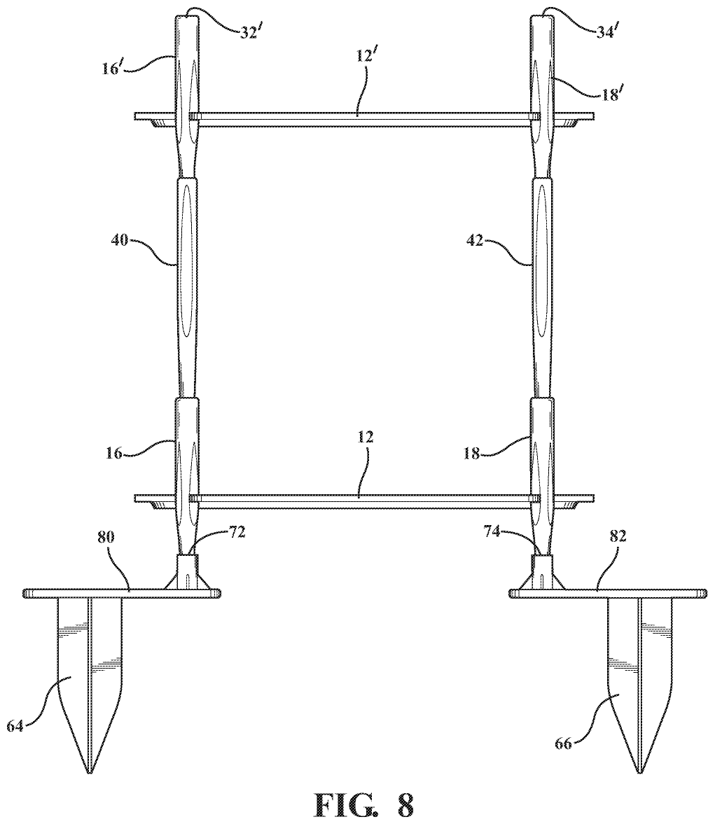

FIG. 5 is a bottom plan view of the embodiments of FIGS. 1-4 and better showing the optional square cross sectional profile associated with the intermediate location of each tier defining portions 16-22 and length extending portion 40-46. FIG. 6 is an assembled perspective view of the modular kit and assembly according to the variant for directly stacking the hoop shaped components one atop another and without use of the intermediate spacers, with FIG. 7 an exploded perspective view of the kit and assembly shown in FIG. 6 and FIG. 8 an assembled front plan view. For purposes of the illustrations, additional tiered hoop shaped components 12′ and 12′ are referenced, along with identical nomenclature associated with the respective identical features of each additional component.

FIG. 9 is an exploded view of the kit and assembly according to a further variant and which is largely identical to that shown in FIG. 1, with the exception of the reconfiguration of the feet stakes, previously shown at 80, 82, 84 and 86 and now which are reconfigured as shown at 180, 182, 184 and 186. The feet or ground stakes, similar to those depicted in the embodiment of FIG. 1, each further include a flattened intermediate planar surface, such as having any of a round or elliptical shape and which are again referenced at 180-186, in combination with an upper located pair of finger graspable retrieval/withdrawal wings or tabs, see further at 188/190, for stake 180, 192/194 for stake 182, 196/198 for stake 184 and 200/202 for stake 186, these permitting easy retraction and removal of the ground stakes when desired.

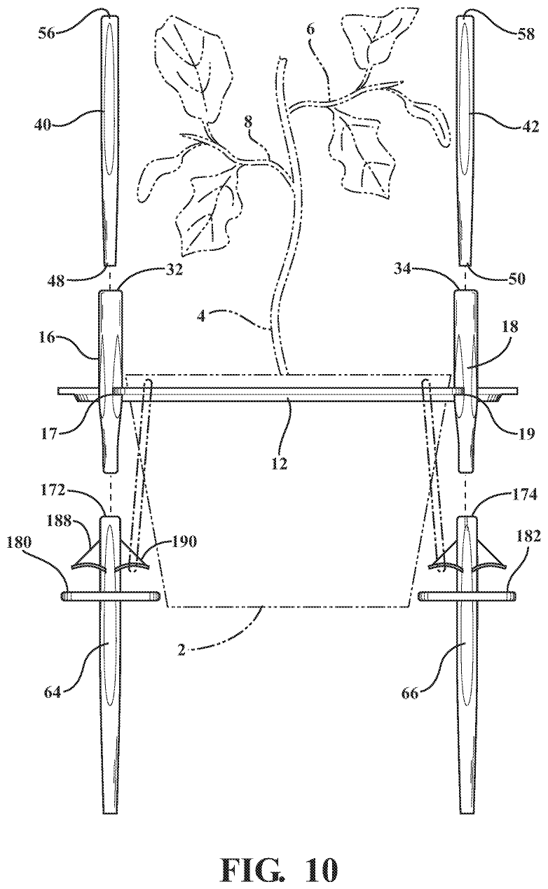

FIG. 10 is a front plan view of the exploded embodiment of FIG. 9 and, similar to FIG. 2, again further illustrating in phantom,a plant bucket having an upper rim location to which a lower-most hoop component can be configured to engage in a further supporting arrangement not requiring the feet stakes. As is also shown in FIG. 1, upper end disposed receiving sockets 172-178 are configured in each of the stakes 180-186 for receiving lower inserting ends 24-30 of the vertically extending portions 16-22.

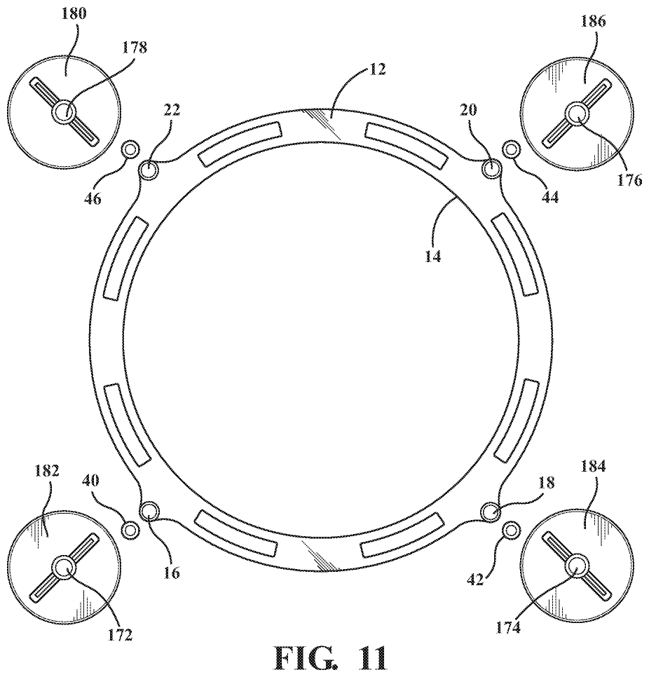

FIG. 11 (similar to FIG. 3) is a top plan view of the embodiment of FIGS. 9-10 and illustrating the height extending portions and feet stakes positionally radially outwardly from the perimeter of the hoop shaped component for purposes of clarity of presentation.

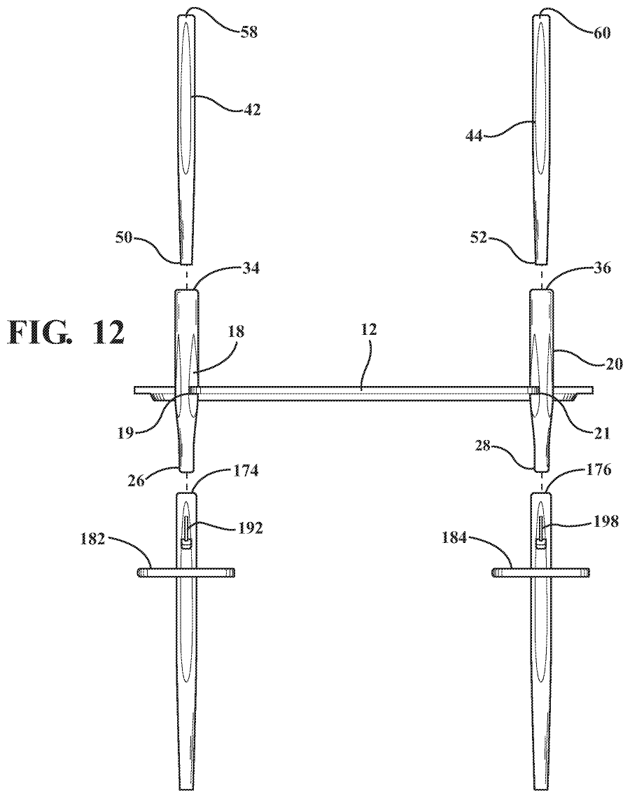

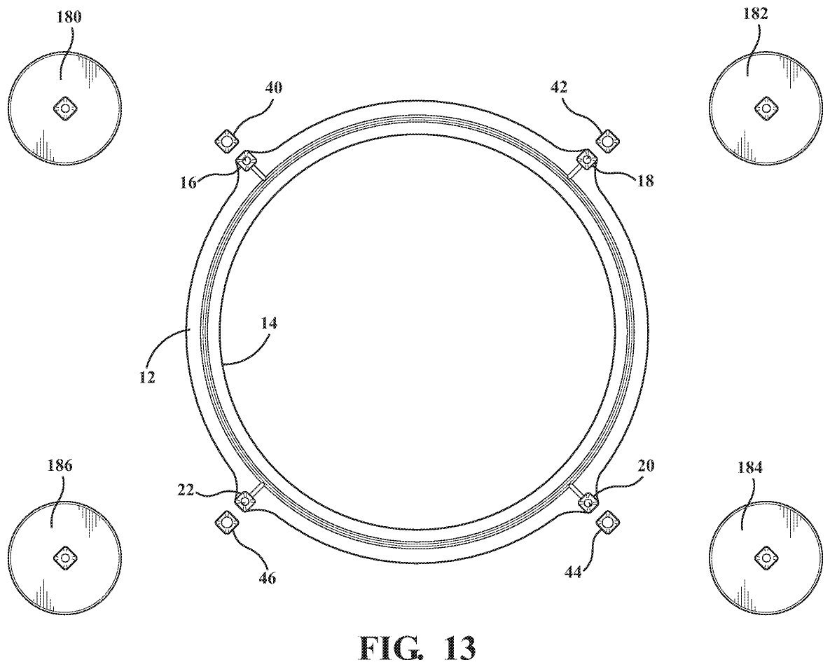

FIG. 12 is a ninety degree rotated side plan view of the exploded embodiment of FIG. 10 and FIG. 13 is a bottom plan view of the embodiments of FIGS. 9-12.

The present invention also discloses an associated method for utilizing a modularly stackable kit for providing stem, branch and foliage support for a planting, and which includes the steps of providing a plurality of hoop shaped components, each exhibiting an open interior adapted to encircle and support the planting, providing a plurality of vertically elongated portions arranged in perimeter defined fashion about each of the components, such that an intermediate location of each of an individual plurality of the tier defining portions is integrated into each of the hoop components.

Additional steps include providing a plurality of elongated ground engagement stakes, embedding the stakes in the ground by pressing down on a flattened planar surface at an intermediate location of each of the stakes and subsequently removing the stakes by engaging a pair of finger graspable retrieval tabs located above the flattened planar surface.

Yet addition steps include arranging a first of the plurality of shaped components proximate a base of the planting so that lower ends of the vertically elongated portions inter-engage with upper ends of the ground engagement stakes and successively installing at least one additional of the plurality of hoop shaped components by interengaging upper and lower opposing ends of the vertically elongated portions of the succeeding components in tiered defining fashion around the planting.

Having described my invention, other and additional preferred embodiments will become apparent to those skilled in the art to which it pertains and without deviating from the scope of the appended claims. This can include the hook shaped and other height extending/ground engaging components also potentially including a pressed biodegradable material which can be placed in an outdoor environmental condition and potentially biodegrade or wear away over time concurrent with the growing and rooting of the foliage.

I claim:

1. A kit for providing stem, branch and foliage support for a planting, comprising:
a plurality of hoop shaped components, each exhibiting an open interior adapted to encircle and support the planting;
a plurality of vertically elongated portions extending from perimeter locations of each of said components, each including upper and lower inter-engaging ends for stacking said components in tiered fashion; and
a plurality of elongated ground engagement stakes, each including a flattened and intermediate located planar surface adapted for embedding the stakes in the ground, in combination with an upper located pair of finger graspable retrieval tabs adapted for retracting the stakes from the ground, said stakes each further including upper ends for engaging with said lower ends of a lower most hoop shaped component.

2. The kit as described in claim 1, further comprising elongated and height extending portions interposed between each of the integrated tier defining portions in order to increase the vertical spacing between said hoop shaped components.

3. The kit as described in claim 1, further comprising said lower-most hoop shaped component configured to engage an upper rim location of a planting supporting bucket.

4. The kit as described in claim 1, said upper and lower inter-engaging locations of each of said vertically elongated portions further comprising male and female end configured portions.

5. The kit as described in claim 1, further comprising each of said hoop shaped components having flexural properties.

6. The kit as described in claim 1, further comprising each of said components, vertically elongated portions and stakes being constructed of an injection molded thermoplastic material.

7. A method for utilizing a modularly stackable kit for providing stem, branch and foliage support for a planting, said method comprising the steps of:
providing a plurality of hoop shaped components, each exhibiting an open interior adapted to encircle and support the planting;
providing a plurality of vertically elongated portions arranged in perimeter defined fashion about each of the components, an intermediate location of each of an individual plurality of the elongated portions being integrated into each of the hoop components;
providing a plurality of elongated ground engagement stakes;
embedding the stakes in the ground by pressing down on a flattened planar surface at an intermediate location of each of the stakes and subsequently removing the stakes by engaging a pair of finger graspable retrieval tabs located above the flattened planar surface;
arranging a first of the plurality of shaped components proximate a base of the planting so that lower ends of the vertically elongated portions inter-engage with upper ends of the ground engagement stakes; and
successively installing at least one additional of said plurality of hoop shaped components by interengaging upper and lower opposing ends of the vertically elongated portions of the succeeding components in tiered defining fashion around the planting.

8. The method as described in claim 7, further comprising the step of providing a plurality of elongated and height extending portions interposed between each of the integrated tier defining portions in order to increase the vertical spacing between said hoop shaped components.

9. The method as described in claim 7, further comprising the step of engaging a lower-most of said hoop shaped components to an upper rim location of a planting supporting bucket.

10. The method as described in claim 7, further comprising the step of configuring each of said upper and lower ends of the vertically elongated portions with male and female end configured portions.

11. The method as described in claim 7, further comprising the step of incorporating into each of said hoop shaped components flexural properties.

12. The method as described in claim 7, further comprising the step of constructing said hoop shaped components from an injection molded thermoplastic material.
